(19) United States
(12) Patent Application Publication
(10) Pub. No.: US 2014/0359697 A1
(43) Pub. Date: Dec. 4, 2014

(54) Active Security Defense for Software Defined Network

(71) Applicant: Hangzhou H3C Technologies Co., Ltd., Hangzhou (CN)

(72) Inventor: Guang Ji, Beijing (CN)

(73) Assignee: Hangzhou H3C Technologies Co., Ltd., Hangzhou (CN)

(21) Appl. No.: 14/294,839

(22) Filed: Jun. 3, 2014

(30) Foreign Application Priority Data
Jun. 4, 2013 (CN) 201310222656.3

(51) Int. Cl. H04L 29/06

(52) U.S. Cl. CPC H04L 63/0227
USPC 726/1

(57) ABSTRACT

A method is described in which at least one access event matching a predetermined security entry detected by a SDN switch is received; a target host of the access event is determined; and a security validation module corresponding to the predetermined security entry is invoked to obtain a security validation result.

### CROSS-REFERENCE TO RELATED APPLICATIONS

This application claims priority to China Patent Application No 201310222656 3, filed on Jun. 4,2013, entitled “An Active Security Defense Method and Apparatus”, which is incorporated herein by reference.

### BACKGROUND

There are a great number of servers and user terminals existing in a network. Usually, the servers and user terminals are referred to as hosts, and basic function of the network is to provide communication services for these hosts. With the development of network technology, the complexity of network has been increased. Nowadays, network administrators care about not only the implementation of communication services, but also the network security. Within the network, hosts are usually the targets of a variety of network attack, This is the reason that developers have focused on providing security solutions for the hosts from different aspects.

### BRIEF DESCRIPTION OF THE DRAWINGS

FIG. 1 is a block diagram of an example software defined network (SDN) controller.

FIG. 2 is an example flowchart of the active security defense of the SDN controller.

FIG. 3 is a schematic view of an example network environment illustrating the active security defense of the SDN controller.

FIG. 4 is an example configuration interface for administrators.

FIG. 5 is another example flowchart of the active security defense of the SDN controller.

FIG. 6 is an example entry table of a SDN switch.

### DETAILED DESCRIPTION

Network security is not a single measure, but as stereoscopic concept. In order to ensure the host security, network administrators install security software on the hosts adaptable for user terminals. Network administrators may also increase the network devices for defensing attacks, such as firewalls or intrusion prevention system (IPS). By incorporating the security measures, the security of the hosts is greatly enhanced so as to reduce the possibility of being attacked. Large-scale network may also include, in addition to the user terminals, data centers having a great deal number of servers. With the development of virtualized technology, a physical server may be abstracted to a plurality of logical servers, which are referred to as virtual machines. The services provided by a virtual machine are the same as those provided by a physical server. The security measures for the virtual machines and user terminals may be somewhat different due to the operating system installed thereon and the services provided by the virtual machines. For the same reason, there may be also somewhat different secure measures among different virtual machines. With respect to the complex and differentiated security demands, how to effectively perform the network security is a challenge for network administrators of large-scale network.

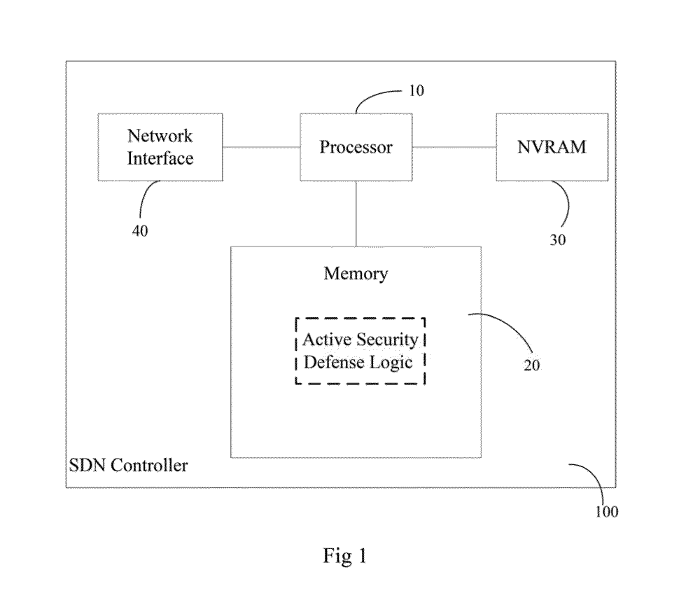

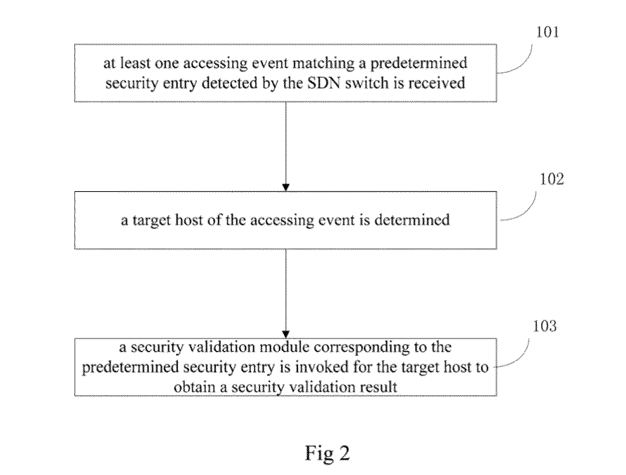

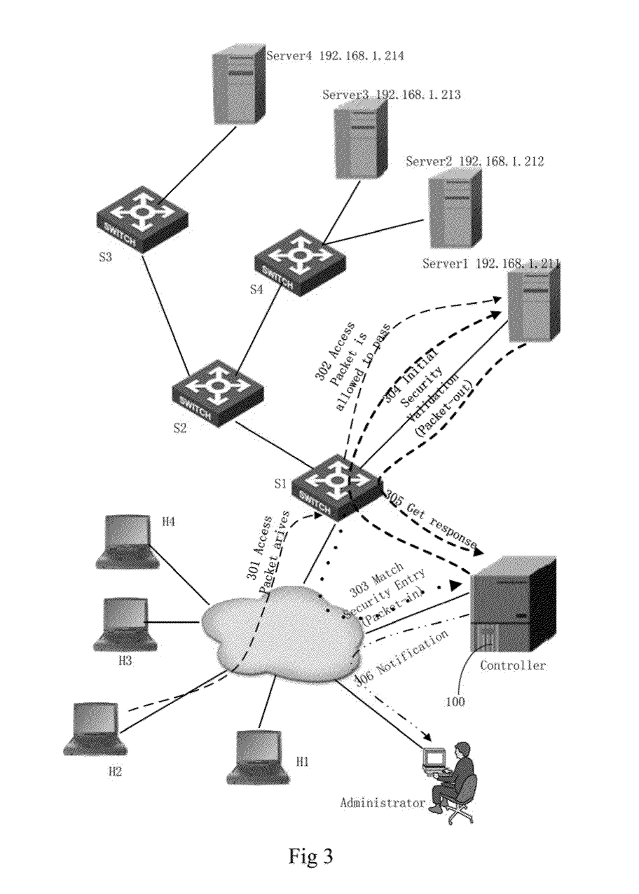

In an example, the active security defense method provided by the SDN infrastructure may detect a network security hole in a real-time manner. FIG. 3 shows an example simplified infrastructure of basic network environment illustrating the active security defense method. The network includes a SDN controller 100 and a plurality of SDN switches (S1, S2, S3, S4). There is a plurality of hosts H1, H2, H3, H4 and each host is connected to the network via one of the SDN switches (S1, S2, S3, S4). OpenFlow protocol is currently the mainstream of SDN technology, and will be taken as the example hereinafter. It is to be noted that other protocols capable of achieving the SDN functions may also be adopted. In this example, the active security defense method is deployed on the example OpenFlow controller by software, which operates transparently for the OpenFlow switch. Referring to FIG. 1, the SDN controller 100 may include a processor 10, a memory 20, as non-volatile memory (NVRAM) 30, and a network interface 40 and these components may be connected via buses. The active security defense method may be implemented by an instruction set, i.e., machine-readable instructions which are executed by the processor. The processor may fetch the machine readable instructions from a non-transitory storage medium such as the memory 20 or a hard disk drive or other storage device into the NVRAM and then execute the method. FIG. 2 is an example flowchart of the active security defense method including the following blocks,

At block 101, notification of at least one access event matching a predetermined security entry detected by the SDN switch is received by the SDN controller.

At block 102, a target host of the access event is determined.

At block 103, a security validation module corresponding to the predetermined security entry is invoked to obtain a security validation result for the target host.

In an example, an access event is an event in which a client or external host attempts to access as target host, such as the host H2 attempts to access server2, as shown in FIG. 3. Within OpenFlow network environment, the security policies deployed on the OpenFlow switches by the OpenFlow controllers are usually presented by at least one entry, which will be described by security entry as an example hereinafter. The security entries are distributed from the OpenFlow controller (“controller”) to an OpenFlow switch (“switch”). The switch saves the security entries in an entry table of the switch, which may for example be a flow table.

Referring to FIGS. 2 and 3, for example, at block 301, as packet is received by the switch S1, and then at block 302, the access packet is allowed to pass. At block 303, the switch S1 queries the entry table and determines if the packet matches as security entry in the entry table of the switch S1. If the security entry is matched, the corresponding action defined in the security entry is executed. The corresponding action may be to report the access event by sending a notification to the controller 100. In an example, at the notification reporting the access event corresponding to the security entry is a packet-in message sent from the switch S1 to the controller 100. Information regarding the security entry may be carried in the packet-in message.

The controller may determine the security entry which has been matched by a serial number or other similar identifiers carried in the packet-in message. The controller may also obtain the identification information of the target host ,such as the IP address and/or the MAC address etc., from the packet-in message because the message has carried the original information of the accessed target host. At this moment, the controller invokes a security validation module corresponding to the security entry for the target host. “Invokes” means that the controller causes a security validation module to be executed.

The security validation process may include an access request or message sent to the target host. However, instead of requesting services provided by the target host, the purpose of the security validation process is to determine whether the target host has a security hole. Examples of security holes include whether the target host has up to date patches (e.g. whether it has upgraded the patch in time) whether the target host has a weak password, etc. Such security holes may make the target host vulnerable to attack. For instance, if the host has upgraded the patch then there would not be a security hole relating to the patch., When the operating system of the target host has upgraded to the latest patch, then even if the current access event relates to a network attack, it may be difficult to cause damage to the target host. Thus up to date patches contribute to the defense against attacks or intrusion. According to the above method, the controller is capable of detecting a security hole of the target host before the target host is accessed. This helps to precisely detect the security risk, which is very useful for network administrators.

In an example, the security entry may relate to one specific host to be protected or relate to a plurality of hosts, such as hosts having the IP addresses within a specific section. Hosts protected by the security method may be termed ‘internal hosts’. Once a packet relating to an internal host has matched a security entry in an entry table of a switch, the switch is triggered to report to the controller, and the security validation process is further triggered. In this way, when security entries are deployed on the switches, any accesses causing security risk, i.e., in which the access packet matches a security entry, may trigger the security validation process. As the controller and switches using the active security method help to monitor host security holes, the network administrator is partly relieved of this burden and may pay more attention to other security risks. Further, , when one specific security hole may be utilized by the attacker, the active security defense method is capable of detecting the suspicious behavior so as to actively validate whether the target host has security hole. In this way, corresponding solution may be adopted according to the security validation result. More detailed examples will be described hereinafter.

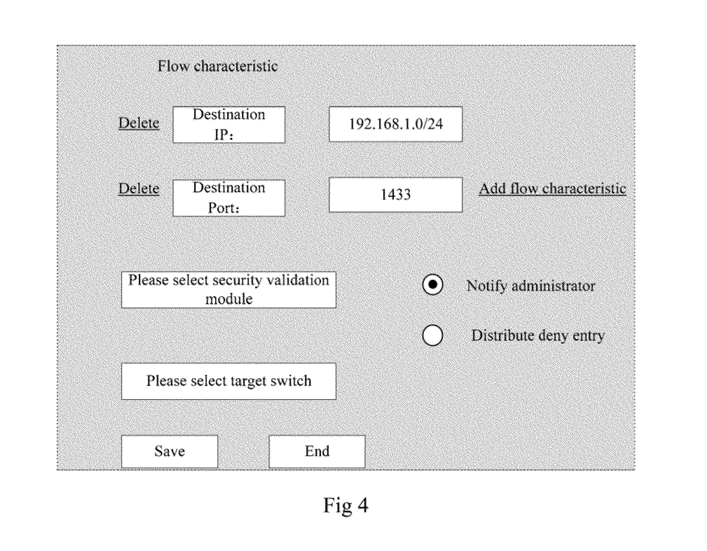

Security entries may be distributed to one or more switches by the controller. For example the network administrator or software may select which switches to distribute a security entry to according to the host or hosts which it is desired to protect. Referring to FIG. 3, the security entries may be deployed on the switch (S1) when Server1 is the host to be protected. Referring to FIG. 4, when the security entries are distributed, the administrator needs to designate the security validation module corresponding to the distributed security entries. On the administrator interface, the administrator needs to reasonably define the flow characteristics for each of the security entry, to select the security validation module corresponding to the security entry, and to determine the target switch to receive the security entry. When the above information are inputted, the controller distributes the security entries to the target switch (S1), and saves the security entries and the corresponding security validation modules selected by the administrator in a non-transitory storage medium of the controller. There are a variety of security validation modules, which may be downloaded from the developers website periodically. The example active security defense infrastructure may be deemed as an application platform for the security validation modules. The developers usually develop the security validation module to detect whether there are security holes according to newly found security holes. The administrators may purchase or download the security validation modules from the application platform.

Referring to FIGS. 3 and 4, when the weak password issue on the SQL server database is the concerned security hole, the corresponding security entries are distributed. For the configuration interface shown in FIG. 4, the administrator may add one flow characteristic having destination port equaling to 1433, which is a famous port for SQL server database. As such, the flow characteristic matches all of the accesses relating to the SQL server database services. If the IP address section utilized by the servers is 192.168.1.0/24, the administrator may add one new flow characteristic, that is, the destination IP address is 192.168.1.0/24. At this moment, the security entry is cooperatively defined by the two flow characteristics. The security entry is matched when the destination port equals to 1433 and the destination IP address is within the section 192.168.1.0/24.

After distributing the security entries to switch (S1) via the configuration interface of FIG. 4, when an external host accesses the SQL server database of Server 1 having the IP address equating to 192.168.1.211, the switch (S1) queries the entry table after receiving the packet. The distributed security entry is matched when the destination port is 1433. The switch reports the packet-in message to the controller. The controller receives the packet-in message and finds out that the security entry of FIG. 4 is matched and the target host is Sever 1. The controller invokes a corresponding security module, which in this example is a weak-password detecting module to determine whether Server1 has the weak password issue.

In an example, at block 304, the weak-password detecting module constructs a corresponding tabular data stream (TDS) protocol requesting packet to be transmitted to switch (S1) via a packet-out way. That is, the requesting packet is transmuted to Server 1 via switch (S1). TDS requesting packet simulates the normal user registration. The TDS requesting packet may be constructed by referencing a plurality of parameters of the original packet carried by the packet-in message. For instance, the parameters may be the destination IP address of the original packet, i.e., IP address of Server1, and the adopted protocol. As the security hole to be validated relates to the weak password issue, the weak-password detecting module constructs the user password of the TDS requesting packet according to the weak password dictionary internally saved. The weak-password detecting module repeatedly construct TDS request packets, and validate each of the passwords in the weak password dictionary. If any one of the weak password has login successfully, Server1 is determined as having security hole relating to weak password. Otherwise, Server1 is determined as having no weak password issue. In an example, at block 305, the controller 100 gets a response from Server1, and then at block 306, the controller 100 sends a notification to the administrator.

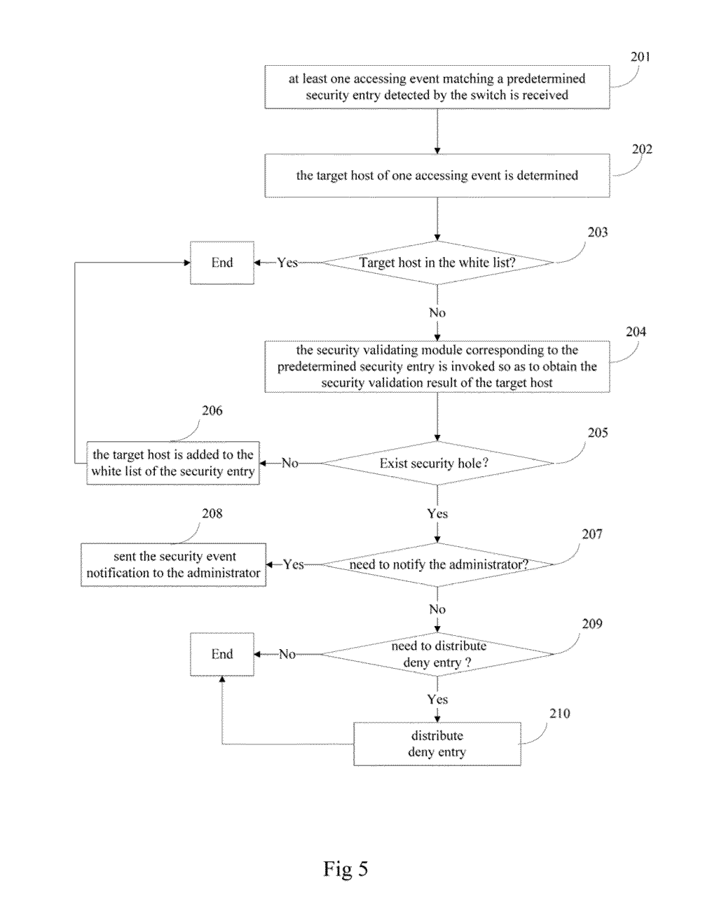

FIG. 5 shows one example of detecting and validating the security hole for the target host so as to obtain the security validation result for the target host. Generally, the security validation results may be that a security hole is found in the target host or no security hole is found in the target host. It is to be noted that the above detecting and validating steps are only examples, and may be achieved alone or in combination, and will be described hereinafter.

In some examples, as illustrated in the flow chart of FIG. 5, the controller may use a white list.

At block 201, at least one access event matching a predetermined security entry detected by the switch is received.

At block 202, the target host of the at least one access event is determined.

At block 203, a determination may be made of whether the target host is in a white list of the security entries. If the target host is in the white list, the process ends. If the target host is not in the white list, the process goes to block 204.

At block 204, the security validating module corresponding to the predetermined security entry is invoked so as to obtain the security validation result of the target host.

At block 205, a determination may be made of whether the target host has security hole. If not, the process goes to block 206. Otherwise, the process goes to block 207.

At block 206, the target host is added to the white list of the security entry, and the process ends.

At block 207, a determination may be made of whether it is needed to notify the administrator. If it is needed to notify the administrator, the process goes to block 208. Otherwise, the process goes to block 209.

At block 208, the security event notification is sent to the administrator.

At block 209, a determination may be made of whether a deny entry has to be distributed. If yes, the process goes to block 210. Otherwise, the process ends.

At block 210, the deny entry is distributed, and the process ends.

At block 202, comparing to the steps in FIG. 2, the controller determines whether the target host is in the white list of the security entries when the received packet-in message matches the security entry. If the target host is not in the white list, the security validation process is invoked at block 204. If the target host is not in the white list and it is determined there is not security hole, at block 206, the target host is added to the white list of the security entry. The controller may add the white list for each security entry. Afterward, when the security entry is matched again, the security validation process has not to be invoked as the target host already exists in the white list of the security entry. It can be understood that the security validation process may consume network bandwidth and the network performance may be affected. With such mechanism, the loading of the controller may be reduced and the times needed to invoke the security validation process is greatly reduced.

If the access event toward the SQL server database of Server 1 has invoked the security validation process and it is determined that there is no security hole, the IP address of Server1, i.e., 192.168.1.211 is added to the white list of the security entry. When another host accesses the SQL server database on Server1 again, as the IP address of Server1 has been added to the white list, the security validation process would not be invoked again. Further, as the login password for SQL server database of Server 1 may be changed by other administrators, the security hole may exist if the changed password relates to weak password. Due to the above reason, the controller counts down a timer with a duration, e.g., one month, for the target host when adding the target host to the white list. When the time ends, the controller removes the target host from the white list. After the target host is removed, the security validation process may be invoked when server1 is accessed by other hosts. In this way, the artificial security holes or the security holes caused by other uncontrollable factors can be greatly reduced.

When determined that there is security holes. Referring to FIG. 4, the are also notifying and denying options shown on the configuration interface. When the notifying option is selected, at block 207, the process goes to block 208 and the controller sends the security event notifications to the administrators. The security event notification may include the IP address of the target host and detailed description of the security hole such that the administrator may manually eliminate the security hole of the target host. Similarly, at block 209, if the denying option is selected, the process goes to block 210 and the controller distributes the deny entry corresponding to the security entry to the switch so as to block the accesses toward the target host. For instance, when the SQL server database of Server1 has security hole, e.g. weak password, the controller distributes the corresponding deny entry to switch (S1) to block other hosts to access the SQL server database of Server1.

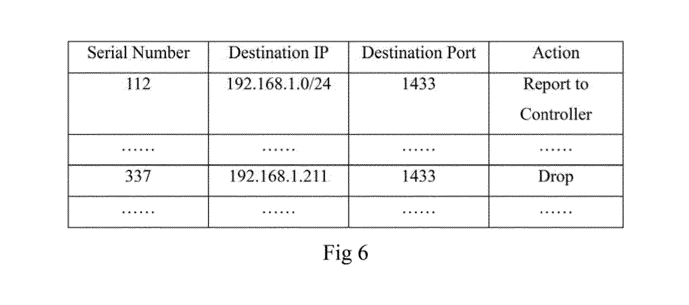

Referring to FIG. 6, the target hosts protected by the security entry may be one IP address section, and the deny entry may relate to one specific target host. In addition to the flow characteristic regarding the target host, other flow characteristics of the deny entry may be carried from the security entry. The actions relating to the security entry is to report to the controller, and the actions relating to the deny entry is to drop the packets. As SQL server database of Server1 may have weak password issue, the deny entry distributed by the controller focuses on the SQL server database service of Server1. The entry may target any access events with IP address equaling to 192.168.0.211 and the destination port equaling to 1433, and the corresponding action is to drop the packet. It is to be noted that the priority of the deny entry is higher than that of the corresponding security entry for the reason that entries of switches are usually queried by priority. When one external host accessing the SQL server database service of Server1, the deny entry with serial number equaling to 337 is firstly matched due to higher priority as shown in FIG. 6. The packet is then dropped so as to protect the SQL server database of Server1. As the packet is dropped, the security entry with serial number equaling to 112 of FIG. 6 cannot be matched. From the safety point of view, the packets regarding the access event may not be sent by attackers. The reason that the packet is dropped is because Served still has security hole. If the external host accesses the SQL server database service of Server2 with IP address equaling to 192.168.0.212, the packet cannot match the deny entry with serial number equaling to 337. The switch (S1) continues querying the entries, and the packet may match the security entry with serial number equaling to 112. At this moment, the security validation process may be invoked again. The deny entry distributed to the switch only works for the target host, and the security entry may operate to protect other hosts. After the security hole is manually eliminated, the administrator may manually delete the deny entry. Afterward, external hosts may access the SQL server database server of Server1.

It is to be noted that, in other examples, the controller may only send the security event notification to the administrator, instead of distributing, the deny entry. Alternatively, the controller may distribute the deny entry without notifying the administrator. In addition, the corresponding notifying and denying options may be omitted so as to make the administrator more convenient. Furthermore, referring to FIG. 3, for the packet matching the security entry, the switch usually admits the packet to pass through unless the packet has been dropped due to matching, other entries. Thus, the deny entry has not been distributed to the switch. Before the deny entry has been distributed to the switch, the security damage is pretty light even though the packet accessing the target host has passed through. It is because that the duration is very short under the circumstance that the target host has security hole and the packet is sent by the attacker.

The foregoing descriptions are only examples of the present disclosure and are not for use in limiting the protection scope thereof. Any modification, equivalent replacement and improvement made under the spirit and principle of the present disclosure should be included in the protection scope thereof.

1. An active security defense method, comprising:
receiving notification of at least one access event matching a predetermined security entry detected by a software defined network SDN) switch;
determining a target host of the access event; and
invoking a security validation module corresponding to the predetermined security entry, wherein the security validation module is to obtain a security validation result for the target host.

2. A method in accordance with the method of claim 1 comprising distributing, by a SDN controller, a security entry to a SDN switch and storing in the SDN controller a correspondence between the security module and the distributed security entry.

3. A method in accordance with the method of claim 1 comprising sending a security event notification upon determining the target host has security hole according to the security validation result.

4. A method in accordance with the method of claim 1 comprising distributing at least one deny entry corresponding to the target host and the security entry upon determining the target host has security hole according to the security validation result, wherein a priority of the deny entry is higher than the priority of the corresponding security entry.

5. A method in accordance with the method of claim 1 comprising:
determining whether the target host is in a white list of the corresponding security entry after the detected access event is received and the target host is determined; and
invoking the security validation module to obtain the security validation result in response to determining that the target host is not in the white list of the corresponding security entry; and
adding the target host to the white list of the corresponding security entry in response to determining the target host has no security bole according to the security validation result.

6. A method in accordance with the method of claim 1 comprising counting down a timer with a predetermined duration upon adding the target host to the white list, and removing the target host from the white list when the duration ends.

7. A SDN controller comprising:
a processor and a non-volatile machine readable storage medium storing instructions executable by the processor to:
distribute at least one security entry corresponding to a specific security hole to the SDN switch connecting a target host to a network;
validate whether the target host comprises the security hole when the security entry is matched; and
prevent the target host from being attacked by access events relating to the specific security hole by the SDN switch upon determining the target host comprises the security hole.

8. A non-transitory machine-readable storage medium encoded with instructions executable by a processor, the machine-readable storage medium comprising:
instructions to receive notification of at least one access event matching a predetermined security entry detected by a SDN switch;
instructions to determine a target host of the access event; and
instructions to invoke a security validation module corresponding to the predetermined security entry to obtain a security validation result.

9. A non-transitory machine-readable storage in accordance with claim 8 comprising instructions to distribute a security entry and save a correspondence between the distributed security entry and the corresponding security validation module.

10. A non-transitory machine-readable storage in accordance with claim 8 comprising instructions to send a security event notification to an administrator upon determining the target host has security hole.

11. A non-transitory machine-readable storage in accordance with claim 8 comprising instructions to distribute at least one deny entry corresponding to the security entry upon determining the target host has security hole, a priority of the deny entry is higher than the priority of the corresponding security entry, and only one flow characteristic regarding the target host of the deny entry is different from that of the security entry, a corresponding action of the deny entry is dropping, and a corresponding action of the security entry is reporting.

12. A non-transitory machine-readable storage in accordance with claim 8 comprising instructions to:
determine whether the target host is in a white list of the corresponding security entry after the detected access event is received and the target host is determined;
invoke the security validation module to obtain the security validation result when the target host is not in the white list of the corresponding security entry; and
add the target host to the white list of the corresponding security entry upon determining the target host has no security hole.

13. A non-transitory machine-readable storage in accordance with claim 12 comprising instructions to:
count down a timer with a predetermined duration upon adding the target host to the white list, and remove the target host from the white list when the duration ends.
